(19) United States
(12) Patent Application Publication
(10) Pub. No.: US 2026/0268638 A1
(43) Pub. Date: Sep. 10, 2026

(54) CLASSIFYING PHYTOPLANKTON CELLS BY A CHANGE IN LUMINESCENCE

(71) Applicant: Oxford University Innovation Limited, Oxford (GB)

(72) Inventors: Haotian Chen, Oxford (GB); Minjun Yang, Oxford (GB); Richard Guy Compton, Oxford (GB); Samuel Barton, Oxford (GB)

(21) Appl. No.: 19/166,216

(22) PCT Filed: Mar. 13, 2024
(86) PCT No.: PCT/GB2024/050683

§ 371 Date: Sep. 17, 2025

(30) Foreign Application Priority Data
Mar. 17, 2023 (GB) 2303955.5

(51) Int. Cl. G06V 10/764; G06V 10/143; G06V 10/60; G06V 10/62; G06V 10/82

(52) U.S. Cl. CPC G06V 10/764; G06V 10/143; G06V 10/60; G06V 10/62; G06V 10/82

(57) ABSTRACT

Methods and apparatus for classifying phytoplankton cells are described. In some examples, the methods comprise acquiring transient data indicative of a change in luminescence of the phytoplankton cell after exposure to excitation radiation and classifying the phytoplankton cell using the transient data as an input to a trained classifier, wherein the classifier is trained using classified transient data for a plurality of phytoplankton cells.

### CROSS REFERENCE TO RELATED APPLICATIONS

This application is a national stage filing under 35 U.S.C. § 371 of international application number No. PCT/GB2024/050683, filed Mar. 13, 2024, which claims priority to GB patent application No. 2303955.5, filed Mar. 17, 2023. The contents of these applications are incorporated herein by reference in their entirety for all purposes.

### BACKGROUND

Phytoplankton are microscopic organisms which live wholly or partly in quasi-suspension in open water and which use chlorophyll to convert sunlight into chemical energy via photosynthesis. Phytoplankton are responsible for nearly 50% of global net primary production (a measure of carbon dioxide consumption), are the primary energy source of aquatic ecosystems and play key roles in Earth's biogeochemistry despite accounting for less than 1% of photosynthetic biomass on Earth. However, phytoplankton are believed to be declining in eight out of ten ocean regions, likely due to climate change.

Understanding phytoplankton is important to understanding marine ecosystems and climate change. Moreover, as some types of phytoplankton are more susceptible to the effects of climate change, the taxonomic distributions of phytoplankton are of interest. As phytoplankton variability is a key driver of biogeochemical variability, an understanding of the variability of phytoplankton may allow for more accurate understanding and for forecasting the extent of global climate change.

Phytoplankton is diverse and can be classified into multiple supergroups, including diatoms, dinoflagellates, coccolithophores, cyanobacteria and more. Examples of phytoplankton at risk from climate change include diatoms and coccolithophores. Diatoms, a key phytoplankton function group that accounts for 40% of the biological pump of CO₂, may be susceptible to climate change, which may be associated with their relatively large size: as climate change causes more nutrient-depleted conditions in the surface ocean, it appears that smaller phytoplankton becomes favoured at the expense of diatoms. For example, Emiliania huxleyi (E. huxleyi) is a coccolithophorid and is considered the most important calcifying species in terms of biomass and carbon sequestration. However, increasing atmospheric CO₂ and ocean acidification has adversely affected calcifying species including E. huxleyi.

Satellite imaging and imaging flow cytometry are two common methods to monitor phytoplankton with different levels of granularity. While satellite imaging covers a great space scale at very high frequencies, it can be obstructed by adverse weather conditions and in any case, such methods cannot be used to observe sub-surface diversity of phytoplankton populations. Selecting proper algorithms and unravelling complex relationships between ocean colour and grouping are another challenge, especially when no phytoplankton group dominates.

Imaging flow cytometry can suffer from low taxonomic resolution, and excess complications caused by multiple magnification objectives and working modes. In addition, not all flow cytometers are adapted for large particles or cells, limiting their use for some diatom and dinoflagellate species. Finally, it can be difficult for even a highly skilled operator to distinguish between some phytoplankton species.

There exists a need for developing alternative, ideally quicker and more reliable, methods to distinguish between phytoplankton species.

### SUMMARY OF INVENTION

According to a first aspect of the invention, a computer implemented method of classifying a phytoplankton cell (which may also be referred to as a phytoplankton particle) is provided. The method comprises acquiring transient data indicative of a change in luminescence of the phytoplankton cell after exposure to excitation radiation and classifying the phytoplankton cell using the transient data as an input to a trained classifier, wherein the classifier is trained using classified transient data for a plurality of phytoplankton cells.

For example, the transient data may have been acquired from images of phytoplankton cells, and/or using fluorescent microscopy. The cells may be exposed to excitation radiation for a period of time. The excitation radiation may be optical radiation, for example fluorescent radiation. A series of images may be acquired while a current is applied and increased until the luminescence of the cells is reduced, for example to zero, or for a period of time. Transient data may be produced by integrating the luminescent intensity of a phytoplankton particle or cell.

In some examples, the transient data may comprise data fully characterising the change in luminescence over a period, which may be the full period for the luminescence to reduce to zero (which may also be referred to as luminescence extinction) or a portion of this time period, for example as time series data. In other examples, the transient data may comprise a characteristic of the change in luminescence, such as for example a half-life period indicative of the time it takes for luminescence to decrease from an initial value to half the initial value. In other examples other characteristics of the data characterising the change in luminescence may be used, such as an average gradient, a stated one or more points in decay (for example, the luminescence values at one third and two thirds of the time to extinction, or the quartiles or the like). In other examples, the transient data may comprise data such as an increase in intensity of luminescence and/or plateaus in intensity of luminescence, changes in gradient of changes in luminescence or other aspects of the shape of the change of the luminescence over time. Any such data may be characteristic of the phytoplankton cell type.

The term ‘classified transient data’ refers to the use of transient data for which the classification is known. Such data may alternatively be described as ‘labelled’ training data, wherein the label is the classification of the cell.

In some particular examples, the transient data is indicative of the change (e.g. decay) in luminescence of the phytoplankton cell after exposure to fluorescence excitation and subsequent inhibition of the luminescence. The transient data may comprise data indicative of one or more wavelengths of light. For example, this may comprise the wavelength of excitation radiation and/or the wavelength of fluorescence.

Classifying a phytoplankton cell may for example comprise classifying the cell by at least one of taxonomic order and ecological group. Moreover, a plurality of cells (hundreds, or even thousands of cells) may be classified using the method.

Phytoplankton species can be classified using their luminescence, for example using fluoro-electrochemical techniques. However, given the large number of phytoplankton species (which is on the order of 5,000), systematically classifying cells using a single parameter is challenging. Moreover, given the richness of phytoplankton species under study, human interpretation and distinction of the resulting luminescence transients becomes increasingly difficult. By using a classifier trained using data indicative of a change in luminescence of a phytoplankton cell after exposure to excitation radiation according to the methods set out herein, a high degree of accuracy of classification can be achieved. Moreover, as further set out below, some methods have been shown to be useful in identifying an unknown (at least to the classifier) species of phytoplankton.

In some examples, the method further comprises acquiring size data indicative of a size of the phytoplankton cell. For example, this may comprise a dimension (e.g. a radius, a diameter, a surface area, a perimeter length) a volume, a shape factor, a weight, a mass or some other indication of the size or the cell. The phytoplankton cell may be classified using the transient data and the size data as inputs to the trained classifier. Moreover, in such examples, the classifier may be trained using classified (or labelled) transient data and size data for a plurality of phytoplankton cells.

Considering size data in addition to the transient data has been shown to improve the accuracy of classification, as will be demonstrated below. This is the case even though size data alone is not particularly useful to a human seeking to classify phytoplankton, as many plankton appear similar in size. However, these act as independent parameters and the accuracy of classification is increased compared to using the transient data alone.

The classifier may comprise a multiclass classifier, capable of classifying cells into a plurality of categories (for example, strains), or a binary classifier, capable of indicating whether or not a cell falls into a given category.

In some examples, the classifier may comprise a trained K Nearest Neighbours, KNN, classifier. In some such examples, transient data may provide at least one dimension of the classifier. Moreover, the KNN classifier may be a multidimensional classifier. In some examples, size data may provide a further dimension of the classifier. In an example, such a classifier may utilise relatively simple transient data, such as half-life data, in conjunction with cell size as inputs to the trained classifier, wherein the classifier is trained using labelled or classified sets of such data.

In other examples, the classifier may comprise a neural network. Such classifiers are well understood by the skilled person and may be adapted for this use case.

In some examples using neural networks, classifying the phytoplankton cell comprises processing the transient data using at least one inception block. Moreover, the method may comprise concatenating an output of the at least one inception block and passing the concatenated output of the at least one inception block to at least one fully connected layer.

Moreover, size data indicative of a size of the phytoplankton cell may be used as an auxiliary input in a neural network. For example, the transient data may be input into an input layer of the neural network, and the method may further comprise inputting an auxiliary input into a subsequent layer of the neural network, the auxiliary input comprising size data indicative of a size (e.g. dimension) of the phytoplankton cell. In some examples, the auxiliary input may be input after processing the data using an inception block. Such data may prevent overfitting of the classifier.

While in some examples, the transient and/or size data may be provided in order to perform the method, in some examples, the method may include extracting the transient data and/or the size from a plurality of images of the phytoplankton cell.

Moreover, in some examples, the method comprises acquiring the plurality of images sequentially after exposing the cell to excitation radiation, for example utilising fluoro-electrochemical microscopy.

The method may further, in some examples, include the step of exposing the cell to excitation radiation prior to acquiring the images.

As noted above, in some examples, the transient data may be indicative of a change in luminescence (e.g. fluorescence) of the phytoplankton cell after exposure to excitation radiation and subsequent inhibition. The inhibition may comprise contacting the phytoplankton cell with an entity, which may comprise any entity which may have an impact on the luminescence, for example causing a change in luminescence, which may be an increase or a decrease in the luminescence, optionally inhibition, reduction and/or ‘quenching’ of the luminescence. Such entities may be referred to herein as “reactive entities”, and may comprise oxidising entities (e.g. an entity that is capable of oxidising at least part of a phytoplankton cell), which may be electrochemically generated. For example, the inhibition may comprise in situ inhibition of a cell's chlorophyll-a fluorescence using electrogenerated reactive entities, e.g. oxidative radicals, in seawater.

According to a further aspect of the invention, a computer implemented method of training a classifier to classify a phytoplankton cell comprises acquiring classified transient data indicative of a change in luminescence of each of a plurality of phytoplankton cells after exposure to excitation radiation. The method further comprises training a classifier using classified transient data for the plurality of phytoplankton cells. The transient data may be transient data as described above.

In some examples, the method further comprises acquiring labelled size data indicative of a size of the phytoplankton cells. For example, the size data may be size data described above. In such examples, training the classifier may comprise training using classified transient data and size data for a plurality of phytoplankton cells.

In some examples, the method comprises extracting transient and/or the size data from a plurality of images of the phytoplankton cell. The method may further comprise acquiring the images, and may comprise exposing the cell to excitation radiation prior to acquiring the images, as described above.

According to a further aspect of the invention, there is provided a computer readable medium bearing instructions which, when executed, carry out the methods described herein.

According to a further aspect of the invention, a phytoplankton classification apparatus comprises a trained classifier, wherein the classifier is trained using labelled transient data for a plurality of phytoplankton cells wherein the transient data is indicative of a change in luminescence of the phytoplankton cell after exposure to excitation. The classifier is operable, in an operation phase, to receive transient data indicative of a change in luminescence of a phytoplankton cell after exposure to excitation. The classifier is further operable, in the operation phase, to classify the phytoplankton cell.

In some examples, the classifier comprises at least one image analysis module which is configured to extract the transient data from luminescence images of phytoplankton cells and to provide the transient data to the classifier. For example, this may comprise time-series data indicative of a change in luminescence, or data characterising the transient data, such as a half-life (or more generally, at least one threshold time to x % of luminescence reduction, where x is between 0-100), an increase in intensity of luminescence and/or plateaus in luminescence, changes in gradient or other aspects of the shape of the change of the luminescence over time which may be characteristic of the phytoplankton cell type, as described above.

For example, the image analysis module may utilise luminescence images captured during fluoro-electrochemical experiments as a source of labelled transient data.

In some examples, the trained classifier is trained using size data (for example, a radius, diameter, surface area, perimeter length, volume, weight, mass or the like) for a plurality of phytoplankton cells. In such examples, the classifier is further operable to, in the operation phase, receive the size data and to input the size data into the trained classifier to classify the phytoplankton cell. In some examples, the input data may be used as an auxiliary input in a neural network, as described above.

In some examples the image analysis module may be configured to extract the size data from images of phytoplankton cells and to provide the size data to the classifier.

In some examples, the trained classifier comprises a trained K Nearest Neighbours, KNN, classifier. Such a classifier may be operable, in the operation phase, to receive relatively simple transient data, for example transient data comprising a half-life of a decay in luminescence. In some such examples, transient data may provide at least one dimension of the classifier, and, optionally, size data may provide a further dimension of the classifier.

In other examples, the trained classifier comprises a neural network. In some examples, the neural network comprises at least one inception block and/or at least one fully connected (dense) layer. As mentioned above, in some examples, such a classifier may receive an auxiliary input comprising size data indicative of a size of the phytoplankton cell, for example as an input into at least one of the fully connected layers. In some examples, the auxiliary input is provided into a layer which precedes the penultimate layer.

In some examples, the apparatus may further comprise apparatus to cause phytoplankton cell(s) to luminesce. For example, the apparatus may comprise a light source that emits light at a suitable wavelength to excite the phytoplankton cell, for example to induce fluorescence of a phytoplankton cell. The apparatus may comprise a device for monitoring the luminescence of the phytoplankton cells, e.g. the image analysis module described herein. Alternatively or additionally, the apparatus may comprise a device, e.g. an electrochemical device, to generate a reactive entity for inhibition of luminescence of the phytoplankton cell. In an embodiment, the device comprises an apparatus to cause phytoplankton cell(s) to luminesce, a device for monitoring the luminescence of the phytoplankton cells and/or a device e.g. an electrochemical device, to generate a reactive entity for inhibition of luminescence of the phytoplankton cell.

In an example, the light source may emit fluorescence excitation radiation. The light source may emit light. The light may be any suitable light for inducing fluorescence of phytoplankton cells, for example ultraviolet, visible or infrared light, preferably visible light, preferably having a wavelength of between 400 nm to 650 nm, preferably from 400 nm to 550 nm, preferably 440 nm to 510 nm.

The apparatus may comprise a device to measure the luminescence of the phytoplankton. The device may be a fluorescence microscope, optionally an epifluorescence microscope (in which excitation and emission light both pass through the same objective lens of the microscope) or a device comprising an excitation light source (for example, at least one LED and/or laser) and a light sensitive diode to measure the luminescence of the phytoplankton.

The apparatus may comprise a device to generate a reactive entity for inhibition of luminescence of the phytoplankton cell; and the device may generate the reactive entity mechanically, e.g. releasing a reactive species into a reaction chamber, such that it then contacts the phytoplankton cell, or chemically, e.g. in a chemical reaction, for example electrochemically, e.g. by passing a current through a redox-active entity to generate a reactive entity, i.e. an entity that is capable of oxidising at least part of a phytoplankton cell. The apparatus may comprise an electrochemical device to generate a reactive entity for inhibition of luminescence (e.g. fluorescence) of the phytoplankton cell. The electrochemical device may comprise a chamber comprising electrodes and which can hold the phytoplankton cell and a redox-active entity. The chamber may comprise a housing containing the electrodes and which can hold the phytoplankton cell and a redox-active entity, optionally a housing that can hold a liquid, such as water.

The device to measure the luminescence may measure the luminescence, e.g. phosphorescence or fluorescence, as the luminescence is induced and, optionally, inhibited, e.g. as a reactive species is generated, e.g. by passing a current between a working electrode and a counter electrode of an electrochemical device, at a sufficient potential to generate a reactive species such that the luminescence of the phytoplankton is inhibited. The reactive species may be a radical generated from a redox-active entity. The redox-active entity may be selected from water, inorganic compounds and organic compounds. The inorganic compounds may be negative anions, which may be dissolved in the liquid, e.g. water. The negative anions may, for example, be a halide, e.g. selected from a fluoride, a chloride, a bromide, and an iodide. The organic compounds may contain an oxidisable group, such as a hydroxyl group. The reactive entity may be a free radical, e.g. a radical selected from HO·, HOO· and an inorganic free radical or an organic free radical.

The potential applied may be an oxidative potential. The potential may be selected to be sufficient to generate reactive species from seawater or a medium containing the phytoplankton. The potential, which may be an oxidative potential, may be at least 1 V versus a silver pseudo-reference electrode, optionally at least 1.2 V, optionally at least 1.4 V, optionally at least 1.7 V, preferably at least 1.9 V. When the redox-active entity is water, 1.9 V is considered to generate hydroxyl radicals in sufficient concentration to inhibit luminescence of the phytoplankton. However, in other examples the potential may be up to +/−5V. The reactive entity is considered to act in some embodiments to diffuse or otherwise enter the cell. Once it has entered the cell, it may degrade or in some way quench, turnoff, or destroy the luminescent species, i.e. a chlorophyl compound, such as chlorophyll-a.

The chamber may comprise a working electrode (i.e. the working electrode that is used to electrochemically generate the reactive entity) and a counter electrode and optionally a reference electrode. The electrodes may comprise any suitably electrically conducting material, for example, a metal, an alloy of metals, and/or carbon. The electrode may comprise a transition metal for example, a transition metal selected from any of groups 9 to 11 of the Periodic Table. The electrode may comprise a metal selected from, but not limited to, rhenium, iridium, palladium, platinum, copper, indium, rubidium, silver and gold. If the electrode comprises carbon, the carbon may be selected from edge plane pyrolytic graphite, carbon fibre, basal plane pyrolytic graphite, a glassy carbon, boron doped diamond, highly ordered pyrolytic graphite, carbon powder and carbon-nanotubes. In some embodiments, the working and reference electrode are both carbon electrodes, and the carbon of each may be selected from edge plane pyrolytic graphite, carbon fibre, basal plane pyrolytic graphite, a glassy carbon, boron doped diamond, highly ordered pyrolytic graphite, carbon powder and carbon-nanotubes. In an embodiment, the working electrode comprises a glassy carbon electrode and the reference electrode comprises graphite, and optionally both are elongate and optionally in the form of a rod or wire. The counter electrode and if present the reference electrode may be made from the same materials. “Reference electrode” includes within its meaning herein pseudo-reference electrodes and standard reference electrodes, including, but not limited to, a calomel electrode or a silver/silver chloride electrode.

The working electrode and counter electrode may have any appropriate size. The electrode(s) may be a macro electrode (maximum distance of 1 mm or more across the electrode) or a microelectrode (maximum distance of less than 1 mm across the electrode). For example, the electrode(s) may have a maximum distance across a face of the electrode of from 1 nm to 10 cm, optionally from 10 nm to 5 cm, optionally, from 100 nm to 1 cm, optionally, from 500 nm to 5 mm, optionally, 1 micron to 1000 microns, optionally from 1 micron to 500 microns, optionally from 1 micron to 50 microns, optionally from about 2 to 10 microns, in an example, about 7 microns. In some embodiments, the working electrode may have a diameter from about 1 mm to about 5 mm, optionally about 2 mm to about 4 mm, optionally about 3 mm. In some embodiments, the working electrode and counter electrode are of equal size.

The working electrode and/or counter electrode may be an elongated electrode, e.g., in the form of a wire or fibre, i.e. such that it has a longest dimension, e.g. the length, that is longer than two dimensions perpendicular to the longest dimension. The elongated electrode(s) may have a diameter of from 1 nm to 10 cm, optionally from 10 nm to 5 cm, optionally, from 100 nm to 1 cm, optionally, from 500 nm to 5 mm, optionally, 1 micron to 1000 microns, optionally from 1 micron to 500 microns, optionally from 1 micron to 50 microns, optionally from about 2 to 10 microns, in an example, about 7 microns. In some embodiments, the working electrode may have a diameter of from about 1 mm to about 5 mm, optionally about 2 mm to about 4 mm, optionally about 3 mm.

In some embodiments, the working electrode forms part of an electrochemical chamber also comprising a reference electrode of any dimensions and/or a counter electrode of appropriate size.

In some embodiments, the electrochemical chamber has any suitable geometry. The shape and configuration of the electrode(s) may not be restricted. The electrodes may be in the form of points, lines, rings or flat planar surfaces. In an embodiment, the working electrode and the counter electrode are disposed within a housing. In an embodiment, the working electrode and reference electrode are disposed on the same face of a housing. Any part of the chamber may have been 3D printed.

In some embodiments, a working and counter electrode are disposed within a chamber, and both the working electrode and counter electrode are elongated, e.g. in the form of a wire or a rod, e.g. a carbon fibre, and they are parallel or substantially parallel to one another. In some examples an elongated reference electrode is also provided and is also parallel to the working and counter electrodes.

In some embodiments, the chamber comprises a transparent material on at least one side of a housing, e.g. a transparent plate, (e.g. a slide, e.g. glass slide) disposed on one side of the chamber. This may allow the luminescence of the phytoplankton to be monitored. This may also allow the dimensions of the particle/cell to be observed and recorded during the method.

In some embodiments, the housing comprises a flat side, having a flat surface facing the phytoplankton particle/cell and the carrier liquid, and the flat side may be in a substantially horizontal plane during the method (i.e. such that a direction perpendicular to the flat side is parallel to the direction of gravity), and a side of the housing on the opposite side of the chamber, which may also be flat, may be transparent to allow monitoring of the luminescence of phytoplankton. In some embodiments, the working electrode is disposed between the counter electrode and reference electrode in the chamber, and optionally all the electrodes are elongated and parallel to one another.

In some embodiments, the electrochemical chamber has any suitable size or depth. In some embodiments, the electrochemical chamber has a depth (e.g. from one side of the housing to another side of the housing, at least one of which may be a transparent side of the housing) of from 10 microns to 1000 microns, in one example, about 100 microns. The dimensions of the chamber perpendicular to the depth (which may be termed length and width) may each independently be from 0.1 cm to 5 cm, optionally from 0.1 cm to 2 cm, optionally from 0.5 cm to 2 cm. The chamber may hold a volume of liquid of from 0.01 cm³ to 100 cm³, optionally from 0.1 cm³ to 10 cm³. In some embodiments, the phytoplankton is in contact with the electrode, e.g., wherein the phytoplankton has been dropcast onto the electrode.

### BRIEF DESCRIPTION OF THE FIGURES

Embodiments of the invention will now be described by way of example only and with reference to the Figures, in which:

FIG. 1 is a representation of time series data showing examples of changes in luminescence of a plurality of different species of phytoplankton.

FIG. 2 is a flow chart of a method of classifying phytoplankton cells according to a first embodiment of the invention.

FIG. 3 is a scatter chart of radius and a half-life of a decay in luminescence of a plurality of different species of phytoplankton.

FIG. 4 is a flow chart of a method of classifying phytoplankton cells according to a second embodiment of the invention.

FIG. 5 is an example of a neural network which may be used in some embodiments of the invention.

FIGS. 6 and 7 are examples of apparatus for classifying phytoplankton which may be used in some embodiments of the invention.

### DETAILED DESCRIPTION

Examples herein concern training classifiers to classify phytoplankton cells, and/or to use of such classifiers using transient data indicative of a change of luminescence of cells following exposure to excitation radiation. Moreover, size data indicative of a size of a cell may be used in some examples.

To consider first an example of a method trained without reference to transient data to provide a comparison, the inventors of the methods set out below collected 3325 images of 29 phytoplankton strains. The dataset was further split into a training dataset (80%) and a testing dataset (20%), and when training a neural network, 10% of the training dataset was reserved for validation. The images were recorded in grayscale and resized to 80 pixels with equal width and height.

The strains included in the dataset are set out in Table A of the Appendix, with the number of images of each strain shown in the column marked ‘#images’. Table B shows the distribution of the different ecological groups. The dataset was selected to be relatively balanced and to provide a good proxy of a real-world phytoplankton classification challenge.

A pre-trained ResNet50V2 neural network was fine-tuned using transfer learning to provide a trained classifier. In this example, ResNet50V2 was directly imported from the TensorFlow Keras applications library with pretrained weights from “imagenet”. The output layers were GlobalAveragePooling2D with fully connected layers, containing either 10 neurons for classification into taxonomic orders or 4 neurons for classification into ecological groups. Transfer learning with ResNet50V2 had two stages: a shorter first stage of initial training at a normal learning rate (10⁻³) while freezing all layers except for the output layer and a longer second stage, fine tuning all layers at a small learning rate (10⁻⁵). The loss function was categorical cross entropy, and the optimizer was Keras' Adam optimizer, which uses a stochastic gradient descent method based on adaptive estimation of first-order and second-order moments.

The trained classifier was evaluated by classifying phytoplankton images to their taxonomic orders on the testing dataset, achieving an accuracy of 86.5%. While this is high, it is far from perfect accuracy.

The training time was measured on a workstation with Intel-6700K CPU, 32 GB of RAM and a Nvidia V100 card as being 4.5 minutes.

It was noted that while this classifier achieved a training accuracy >99% after 30 epochs of fine tuning, the validation accuracy stalled around 84%. In other words, the network was able to classify the training data with a 99% accuracy, but when instead the reserved validation and testing data was input, the accuracy was much reduced, suggesting that the classifier suffered from overfitting.

To consider now examples which do make use of the transient data, in each of the examples which follows, time series transient data corresponding to 2911 luminescence transients was acquired. It may be noted that, in examples herein, the number of images in the image dataset described above is greater than the number of transients described. While the source of both these datasets was the same, in some samples, phytoplankton cells drifted outside the window of view the during the time scale of experiment and such samples were removed from the transient dataset. The image dataset was made up of one correctly recorded image for each sample, and thus includes images taken in experiments which did not result in complete transient data.

While other apparatus may be used in other examples, in this example, to acquire the transient data and the image data described above, an opto-electrochemical chamber housed a three-electrode setup: a glassy carbon electrode (diameter=3.00 mm, BASi, USA) as a working electrode, a saturated calomel electrode (SCE, ALS distributed by BASi, Tokyo, Japan) as a reference electrode and a graphite carbon rod as a counter electrode. 50 μL of phytoplankton culture were dropcasted onto the electrode. The phytoplankton cells were allowed to settle onto the working electrode for approximately one minute before the chamber was filled with electrolyte.

The dropcasted phytoplankton cells were first exposed to continuous fluorescence excitation (λₑₓ=475±35 nm) for 60 seconds. The excitation light source was a LQ-HXP 120V Lamp. A series of fluorescence images were taken at 10 frames per second throughout the experiment. From t=60 s (t=tₒₙ), a current was applied and ramped from 0 μA at a rate of 10 μA s⁻¹ until the fluorescence from the cells was completely switched off.

While other microscopes and/or cameras may be used, in this example Optical images were taken on a Zeiss Axio Examiner, A1 Epifluorecence microscope (Carl Zeiss Ltd., Cambridge U.K.) using a 20× air objective (NA=0.5, EC Plan-Neofluar). The excitation filter was supplied by Thorlab and the dichromic mirror and emission filter were a Zeiss filter set 15, transmitting emission wavelength above 590 nm. The images and videos to extract fluorescence transients were recorded using a Hamamatsu ORCA-Flash 4.0 digital CMOS camera (Hamamatsu, Japan), providing 16-bit images with 4 MP resolution.

The images were analysed to locate phytoplankton therein. While other image processing software could be used in other examples, in this example, an intensity was extracted using Zen 2 Pro microscopy software. Moreover, a radius of phytoplankton cells was extracted using ImageJ freeware (Fiji distribution) in this example to provide size data. However, any software capable of identifying objects or capable of edge detection could be used in other examples, any other size data may be extracted in other examples.

For the image recognition method described above, in order to provide a consistent dataset, the imaging data for phytoplankton was resized to 80 pixels by cropping with equal width and height. No data transformation or data augmentation was performed.

Fluorescence transients were produced using the source images and by integrating the intensity of a phytoplankton cell, and the intensity was normalized to unity using the value at tₒₙ.

The strains included in the dataset are set out in Table A of the Appendix, with the number of each strain represented in the dataset shown in the column marked ‘#trans’. Table B shows the distribution of the different ecological groups. As above, the dataset was selected to be relatively balanced and to provide a good proxy of a real-world phytoplankton classification challenge, although other distributions could be used in other examples, in particular to mirror an expected distribution of strains in a particular environment. For example, a dataset may be constructed to reflect specific local geographic conditions or particular phytoplankton blooms.

FIG. 1 shows an exemplary set of 29 transients, each providing an example of a particular species, randomly drawn from the examples for each species within the dataset.

In FIG. 1, transients from 0 to 19 seconds are shown. Retaining only a portion of the data in this manner usefully standardizes the dataset. While 19 seconds was used in this example, other time periods could be selected in other examples. In some cases, it may be that the time period is at least 10 seconds, as this corresponds to a typical half-life. The time period in this example starts at initiation the application of an oxidising potential (i.e. at tₒₙ). Since the fluorescence images were taken 10 frames per second and 19 seconds of data was used, in this example, each illustrated transient represents 190 data points.

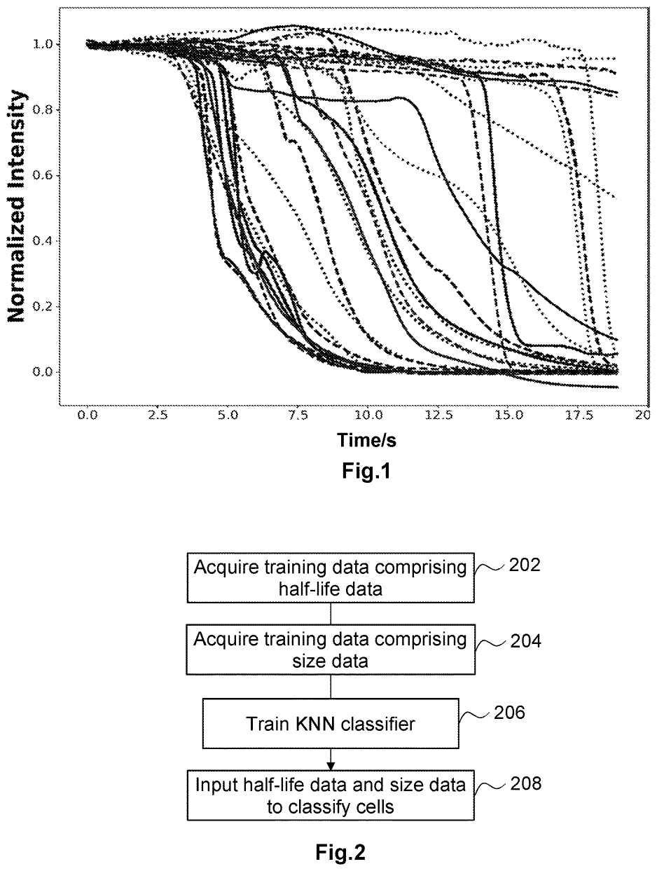

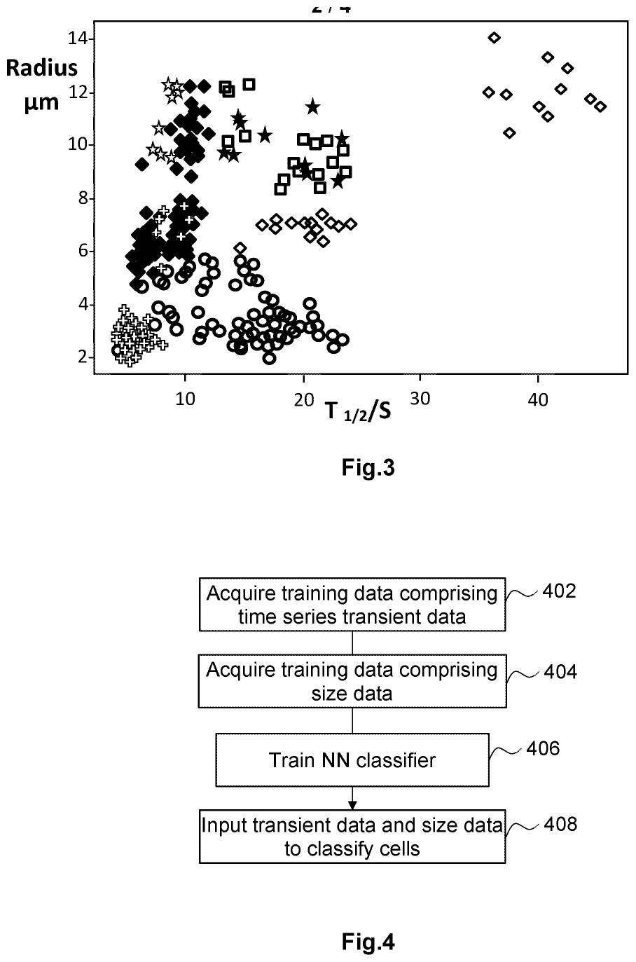

A second method for classification is now discussed with reference to FIGS. 2 and 3, which make use of the transient data described above. In this example a K-Nearest Neighbour (KNN) classifier uses two data points: fluorescence half-life (t_{1/2}) data along with the plankton radii (r), where t_{1/2} is the time point in seconds after initiation of electrolysis when fluorescence intensity of phytoplankton dropped to 50% of its initial value before any oxidizing potential was applied. The half-life is determined before any cropping of the time series described in relation to FIG. 1.

As for the example above, the dataset was split into a training dataset (80%) and a testing dataset (20%).

FIG. 2 is a computer implemented method of training and using a classifier to classify phytoplankton cells. The method may be implemented by one or more processors executing machine readable instructions.

In block 202, labelled or classified transient data is acquired to provide training data. In this example, the transient data is half-life data extracted from the time series data described above. However, in other examples, the half-life data may be provided from a memory, over a network or the like. As mentioned above, while FIG. 1 shows examples in which the time series for transient data is limited to the first 19 seconds, the half-life data may be extracted from a full dataset, modelling the complete decay of fluorescence.

Moreover, in block 204, labelled or classified size data is acquired to provide further training data. This data is extracted from an image associated with each time series using image processing techniques such as edge detection, contrast analysis or the like. In this example, the unit of half-life is seconds and unit of radii is micrometre. These two parameters are numerically comparable in scale, and thus the method avoids over weighting one parameter relative to the other.

In block 206, this data is used to train a classifier. As will be familiar to the skilled person, a KNN algorithm classifies items by finding its closest K neighbours, where K is a hyperparameter. Once the classifier is trained, the closest K neighbours of an unknown input each ‘vote’ and the majority result provides a predicted classification. In some examples votes may be weighted, for example by distance. Thus training the classifier means identifying a value of K, and may also comprise defining the metric of “closest” neighbours and/or a vote weighting. These may be determined by identifying the parameters which provide the highest degree of accuracy for the training data. In this example, the half-life data provides a first dimension of the KNN classifier and the size data (radius) provides a second dimension of the KNN classifier.

In a particular example of training a classifier which may be applicable to the datasets described herein, a search space as shown in Table 1 may be used. Note that the number of neighbours, K, are all odd numbers to prevent draws in voting for uniform weighting, although this need not be the case in all examples.

TABLE 1

| Hyperparameter | Search Space |
|---|---|
| Number of | [3, 5, 7, 9, 11, 13, 15, 17, 19, 21] |
| neighbours, K | |
| Distance metric | [Euclidean, Manhattan] |
| Weights | [uniform, distance] |

Using 5-fold cross validation of the training data described above and GridSearchCV, in an example based on the training dataset described herein, the optimal set of hyperparameters was found to be K=7, using Euclidean distance and uniform weighting. The training accuracy reached 89.0%. The testing accuracy reached 87.5%. Moreover, in this example, the KNN and GridSearchCV methods were imported from a Scikit-learn Python package to provide the classifier, although other sources may be used in other examples.

Such a trained classifier may be used in block 208 to classify new or unseen input data pairs associated with a phytoplankton cell (i.e., in this example, half-life and radius), in order to provide a classification. In the example described herein, the seven nearest neighbours identified using their Euclidean distance ‘vote’ with equal weight (uniform weighting) to provide the classification.

While half-life and radius are used in the example above, it may be noted that there may be other related measures indicative of transient data and/or size which could be used. For example, the transient data may comprise the duration of the full transient, an average gradient, a maximum gradient, and indication of some other interval or the like. The size data may for example comprise a diameter, a circumference, an area, weight, mass, volume, shape factor, etc. In addition, further variables and/or dimensions of the KNN classifier may be added. For example, there may be two or more data points indicative of the change in luminescence, each of which may be used in a multidimensional KNN method. In other examples, data relating to absolute luminescence intensity and/or first and second derivatives of the transient at different time points may be used. In still further examples, data relating to excitation and emission wavelengths may provide additional variables. Moreover, experimental conditions may be considered, such as an effect of electrode potential, current densities used, temperature of seawater and/or the presence of a magnetic field.

Moreover, while the training and the classifying are shown as being part of a single method herein, these processes may be carried out entirely separately from one another.

FIG. 3 illustrates clustering exhibited in phytoplankton data randomly drawn from the dataset. Different markers are provided for the different taxonomic orders. The scatter plot illustrates a degree of clustering by these two parameters/dimensions. This cluster is somewhat unexpected as the cell size and half-life are independent of one another. However, each is characteristic to the taxonomy order of the cell.

Thus, using a relatively simple algorithm with only two features, the KNN classifier achieved higher accuracy than transfer learning with a complex pretrained neural network, as described above. Moreover, the training time may be considerably less: the training time in this example was measured on a workstation with Intel-6700K CPU, 32 GB of RAM and a Nvidia V100 card as being less than 10 seconds, favourably comparing to the 4.5 minutes training (tuning) time of the pretrained image recognition neural network using the same hardware described above.

A third method for classification which makes use of a time series of transient data is now discussed with reference to FIG. 4.

As for the example above, the dataset comprising the transient data was split into a training dataset (80%) and a testing dataset (20%).

FIG. 4 is a computer implemented method of training and using a neural network classifier to classify phytoplankton cells. The method may be implemented by one or more processors executing machine readable instructions.

Block 402 comprises acquiring labelled or classified transient data, in this example comprising time series data indicative of a change of luminescence of each of a plurality of phytoplankton cells to provide training data. In a particular example the time series data comprises luminescence measurements taken at regular time intervals following excitation. The time series for each phytoplankton cell may span a corresponding time interval following excitation and may be taken at corresponding intervals. For example, as described above, the time series data may comprise data acquired at 0.1 second intervals for a time period of 19 seconds following application of a potential. However, it will be appreciated that the data could be acquired more or less frequently, and/or over a longer or shorter time period. Moreover, the time interval between each reading need not be the same (although the timing of the readings is preferably consistent for time series data taken for different phytoplankton cells).

Block 404 comprises acquiring labelled or classified size data associated with each set of transient data to provide further training data. For example, as described above, this may comprise a radius, although other indications of size (e.g. diameter, surface area, circumference, volume, mass etc.) could be used in other examples.

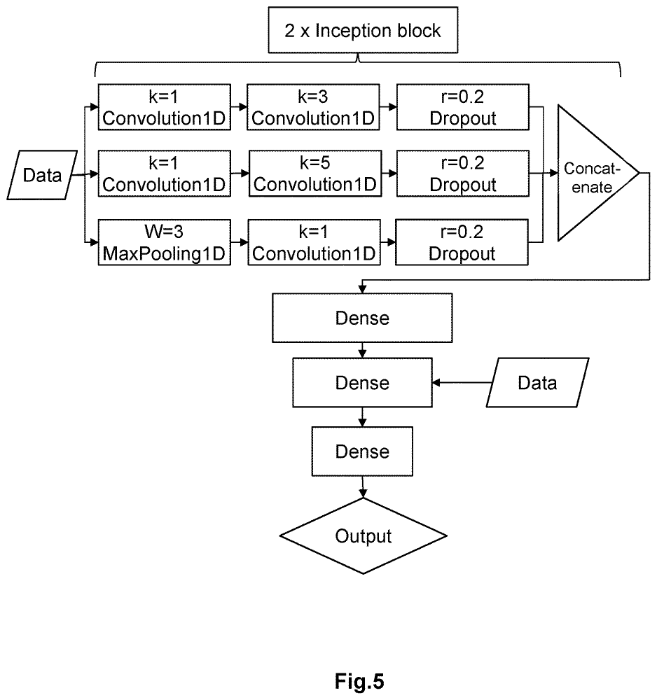

Block 406 comprises training a neural network. In some examples, the neural network is a convolutional neural network. In some examples, the transient data comprises a main or initial input (which may also be referred to as input neurons). The transient data may therefore be input in an input layer of the neural network, and the size data comprises an auxiliary input, which is input into a subsequent layer of the neural network. Use of the size data in this way may assist in preventing overfitting (for example the type of overfitting which was apparent in the image recognition neural network described above). A particular example of a neural network and an associated method of training is discussed in relation to FIG. 5 below.

Block 408 comprises using the trained neural network to classify phytoplankton cells using transient data and size data. As noted above, the transient data may provide an initial input whereas the size data may provide an auxiliary input.

Moreover, while training and use of the neural network are described in a single method above, these processes may be carried out separately.

A particular neural network 500 is now described by way of example with reference to FIG. 5. While other examples of neural networks may be used, in this example, the neural network 500 comprises at least one inception block. Such blocks utilise filters of multiple sizes in a single layer, and are thus able to identify patterns in the data at different resolutions.

In particular, in this example, the neural network comprises two inception blocks. Each inception block comprises four layers. A first layer comprises a 1D convolution block having a 1 by 1 kernel filter (k=1), a 1D convolution block having a 3 by 3 kernel filter (k=3) and a drop out block with a drop out rate of 0.2 (r=0.2). Dropout blocks randomly remove some neurons to reduce overfitting. A second layer comprises a 1D convolution block having a 1 by 1 kernel filter (k=1), a 1D convolution block having a 5 by 5 kernel filter (k=5) and a drop out block with a drop out rate of 0.2. A third layer comprises a maxpool layer having a poolsize of 3 (w=3), a 1D convolution block having a 1 by 1 kernel filter (k=1) and a drop out block with a drop out rate of 0.2. Pooling operations act to downsample the input data. A fourth layer carries out a concatenation of the output of the previous three layers, which operate in parallel. Further detail of each layer is provided in Table c of the Appendix.

The first inception block accepts the transient data, processes it and passes it to the second inception block, the second inception block further processes the data and passes the data. The output from the second block is flattened and further processed for ultimate classification. Use of two blocks provides a good compromise between learning more complicated patterns from the transient data while avoiding overfitting.

The output of the concatenation block is passed to three fully-connected (dense) layers with decreasing width (800, 400 and 100 neurons respectively), with the activation function for these layers being ReLU. The auxiliary input representing the radii of the phytoplankton was merged with the second dense layer. In other examples, the auxiliary input may be merged with the first dense layer. More generally, it was found to be advantageous to add the auxiliary input before the final dense layer.

This provides 11 layers (four for each inception block, and three connected layers), in addition to an input and an output layer. The classifier was trained with fluorescence transients such as those shown in FIG. 1 and as described in Table A. Instances of the classifier were trained for multiclass taxonomic classification (i.e. to identify a taxonomic order of the cell) and for binary identification (i.e. to determine if a cell does, or does not, belong to a taxonomic order).

The activation function for multiclass taxonomic classification for the output layer was softmax:

$${σ ( x )}_{i} = \frac{{e}^{{x}_{i}}}{{\sum }_{j = 1}^{K} {e}^{{x}_{j}}}$$

where σ is the softmax function, xᵢ are the inputs, and K is the total number of classes.

The activation function for binary identification for the output layer was sigmoid:

$$σ ( x ) = \frac{1}{1 + {e}^{- x}}$$

These functions are differentiable at all x and the output is regularized between 0 and 1.

The loss function for binary identification was binary cross entropy:

$$ℒ = - ( y log p + ( 1 - y ) log ( 1 - p ) )$$

For a multiclass classification where K>2, the loss function is categorical cross entropy:

$$ℒ = - {\sum }_{i = 1}^{K} {y}_{o , c} log ( {p}_{o , c} )$$

where y is a binary indicator (0 or 1) if observation o can be correctly classified to class label c and p is the predicted probability observation o is of class c.

After 300 epochs of training, the multiclass classifier described in relation to FIG. 5 achieved an accuracy of 95.4%. Moreover, it significantly more accurately classified isochrysidales and Naviculales, for which the accuracy increased from 30% in the image recognition neural network described above to 90% in this neural network.

It may be noted that, in a similar set up which did not use the size data as an auxiliary input, the accuracy decreased to 92%. This demonstrates the value of using size data as an auxiliary input.

Moreover, the training time was measured on a workstation with Intel-6700K CPU, 32 GB of RAM and a Nvidia V100 card as being 3 minutes, thus proving quicker to train than the inferior image recognition neural network described above.

In this example, a test was carried out to determine if unseen cells (i.e. characterised by data which had not been included in the training data) could be identified. Two tests were carried out using the classifier described in relation to FIG. 5, trained to provide binary classification. In each case, data relating to examples of the E. huxleyi strain (ID=8 in table A) were included, but no samples of ‘interfering species’, i.e. unseen species to be identified as such, were included.

In this case, the classifier was trained to be a binary classifier, intended to identify cells as E. huxleyi or not E. huxleyi. Training the binary classifier using the same neural network takes 20% of the time of training a multiclass classifier mentioned above. In a first scenario, three interference species, Phaeodactylum tricornutum (diatom, ID=1 in Table A), Minidiscus variabilis (diatom, ID=25 in Table A) and Scripsiella trochoidea (dinoflagellates, ID=27 in Table A) were withheld from the training data. In a second scenario, the unseen interference species was Gephyrocapsa oceanica (ID=18 in Table A), a species very similar to E. huxleyi as they are both calcifying isochrysidales.

The neural network was initialized, and the rest of the 29 strains were used for training the classifier for binary classification of E. huxleyi. After 20 epochs of training, the classifier was used to classify unseen strains. The accuracy and F1 score (i.e. measure of a model's accuracy on a dataset) were 97.3% and 96.7% for the first scenario and 94.1% and 95.3% for the second scenario.

In more detail, in the first scenario, 273 E. huxleyi cells were identified correctly. 193 cells which were not E. huxleyi cells were correctly identified as not E. huxleyi. One E. huxleyi cell was classified as not being an E. huxleyi cell, and 12 cells which were not E. huxleyi cells were identified as E. huxleyi cells. In the second scenario, 116 E. huxleyi cells were identified correctly. 201 cells which were not E. huxleyi cells were correctly identified as not E. huxleyi. 16 E. huxleyi cells were classified as not being an E. huxleyi cell, and 4 cells which were not E. huxleyi cells were identified as E. huxleyi cells.

The success of this classification shows that the classifier generalized the transients instead of memorizing them.

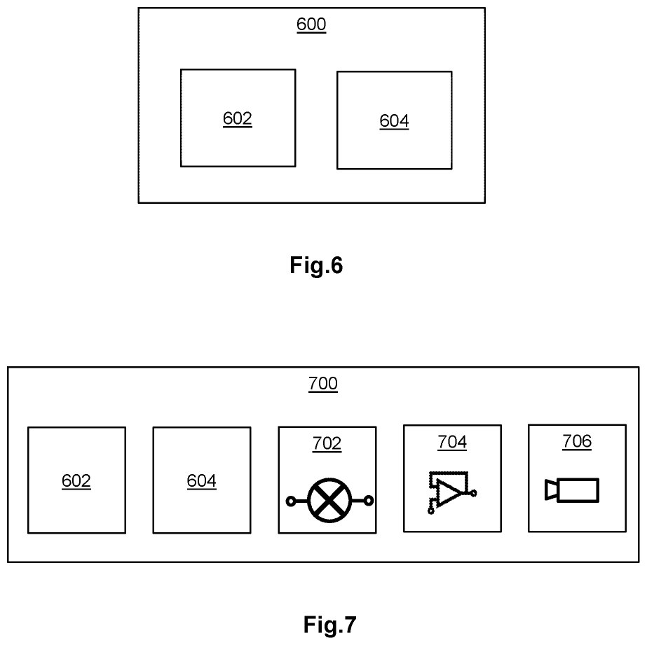

FIG. 6 shows an example of a Phytoplankton classification apparatus 600 comprising a trained classifier 602 which has been trained using labelled (or classified) transient data for a plurality of phytoplankton cells wherein the transient data is indicative of a change in luminescence of the phytoplankton cell after exposure to excitation. The classifier 602 is operable, in an operation phase, to receive transient data indicative of a change in luminescence of a phytoplankton cell after exposure to excitation and to classify the phytoplankton cell. The classifier may for example be implemented by one or more processors accessing machine readable instructions and/or data stored on a memory.

The transient data may comprise time series data indicative of a change in luminescence over time, or may comprise some data characterising this change in luminescence, such as a half-life or the like, as described above.

The trained classifier may for example comprise a trained K Nearest Neighbours, KNN, classifier, as has been described in relation to FIGS. 2 and 3, or may comprise a neural network, for example as described in relation to FIG. 4 or to FIG. 5. Where the classifier is a neural network, it may comprise an inception block and/or at least one fully connected layer. Moreover, in some examples, the neural network may be configured to receive at least one auxiliary input.

As has been further set out above, in some examples, the classifier 602 may have been trained using size data for a plurality of phytoplankton cells, and in such examples, the classifier 602 may be operable to, in the operation phase, receive the size data and to input the size data into the trained classifier to classify the phytoplankton cell. The size data may for example provide an auxiliary input to a classifier comprising a neural network.

Moreover, the apparatus 600 comprises an image analysis module 604. In use of the apparatus 600, the image analysis module 604 is configured to extract the transient data from luminescence images of phytoplankton cells and to provide the transient data to the classifier 602. In some examples, the image analysis module 604 may utilise luminescence images captured during fluoro-electrochemical experiments as a source of labelled transient data. Moreover, in examples which use size data, the image analysis module 604 may be configured to extract the size data from images of phytoplankton cells and to provide the size data to the classifier. The image analysis module 604 may for example be implemented by one or more processors accessing machine readable instructions and/or data stored on a memory.

The apparatus 600 may carry out any of the methods described above, and/or may be implemented by one or more processors executing machine readable instructions. The classifier 602 may be stored on a memory or the like.

FIG. 7 shows an example of a phytoplankton classification apparatus 700 which comprises the trained classifier 602 and the image analysis module 604 described in relation to FIG. 6. In addition, in this example, the apparatus 700 further comprises a light source 702 that emits light at a suitable wavelength to induce fluorescence of a phytoplankton cell. In an example, the light source 702 may emit fluorescence excitation radiation. For example, the radiation may have a wavelength λₑₓ=475±35 nm. The light source may for example comprise a mercury vapour lamp light source. Other suitable light sources may include LEDs, lasers, or filtered sunlight, for example.

The apparatus 700 further comprises an electrochemical device 704 to generate oxidative entities for inhibition of fluorescence of a phytoplankton cell. The electrochemical device 704 may for example comprise a potentiostat or a galvanostat.

The apparatus 700 further comprises microscopy apparatus 706 to acquire images of phytoplankton cells, for example within chambers, as described above. In other examples, alternative devices allowing excitation and emission light to be produced and measured may be used.

In this way, the apparatus 700 can generate its own data by carrying out fluoro-electrochemical experiments, and can classified the observed phytoplankton cells.

While the examples above provide particular examples of different forms of classifiers, it will be appreciated that variations may be made to these classifiers without departing from the invention described herein, which relates to using transient data, or transient data in combination with size data, to train classifiers. Therefore, the scope of the invention is limited only by the claims set out below.

TABLE A
APPENDIX

| | | | | # | # |
|---|---|---|---|---|---|
| ID | Name | Order | Eco_group | Images | Trans |
| 1 | Phaeodactylum | Bacillariophyta | Diatom | 122 | 97 |
| | tricornutum | | | | |
| 2 | Skeletonema japonicum | Thalassiosirales | Diatom | 75 | 71 |
| 3 | Thalassiosira weissflogii | Thalassiosirales | Diatom | 52 | 51 |
| 4 | Nitzchia sp. | Bacillariophyta | Diatom | 82 | 79 |
| 5 | Nitzchia closterium | Bacillariophyta | Diatom | 73 | 63 |
| 6 | Chrysotila dentata(1) | Coccolithales | Coccolithophores | 71 | 69 |
| 7 | Chrysotila dentata(2) | Coccolithales | Coccolithophores | 114 | 107 |
| 8 | Emiliania huxleyi morphA | Isochrysidales | Calcifying | 225 | 205 |
| | light_moderate_calc | | isochrysidales | | |
| 9 | Thalassiosira pseudonana | Thalassiosirales | Diatom | 104 | 60 |
| 10 | Halamphora coffeaeformis | Naviculales | Diatom | 61 | 39 |
| 11 | Calcidiscus leptoporus (1) | Coccolithales | Coccolithophores | 134 | 119 |
| 12 | Calcidiscus leptoporus (2) | Coccolithales | Coccolithophores | 68 | 59 |
| 13 | Calyptrosphaera | Coccolithales | Coccolithophores | 119 | 93 |
| | sphaeroidea | | | | |
| 14 | Coccolithus braarudii | Coccolithales | Coccolithophores | 55 | 52 |
| 15 | Emiliania huxleyi | Isochrysidales | Calcifying | 284 | 278 |
| | morphA/R | | Isochrysidales | | |
| | over_calc_shields(1) | | | | |
| 16 | Emiliania huxleyi haploid | Isochrysidales | Calcifying | 142 | 117 |
| | (1216) | | Isochrysidales | | |
| 17 | Emiliania huxleyi | Isochrysidales | Calcifying | 100 | 84 |
| | naked_diploid(1731) | | Isochrysidales | | |
| 18 | Gephyrocapsa oceanica | Isochrysidales | Calcifying | 138 | 132 |
| | | | Isochrysidales | | |
| 19 | Lepidodinium | Gymnodiniales | Dinoflagellates | 41 | 34 |
| | chlorophorum | | | | |
| 20 | Thoracosphaera heimii | Thoracosphaerales | Dinoflagellates | 171 | 138 |
| 21 | Emiliania huxleyi morphA | Isochrysidales | Calcifying | 328 | 322 |
| | moderate | | Isochrysidales | | |
| 22 | Scyphosphaera apsteinii | Zygodiscales | Coccolithophores | 71 | 68 |
| 23 | Coccolithus pelagicus | Coccolithales | Coccolithophores | 49 | 40 |
| 24 | Coscinodiscus sp. | Coscinodiscales | Diatom | 48 | 40 |
| 25 | Minidiscus variabilis | Thalassiosirales | Diatom | 179 | 126 |
| 26 | Minidiscus comicus | Thalassiosirales | Diatom | 111 | 95 |
| 27 | Scripsiella trochoidea | Thoracosphaerales | Dinoflagellates | 58 | 51 |
| 28 | Heterocapsa triquetra | Peridiniales | Dinoflagellates | 74 | 62 |
| 29 | Emiliania huxleyi | Isochrysidales | Calcifying | 176 | 160 |
| | morphA/R | | Isochrysidales | | |
| | over_calc_bulky_centre | | | | |

TABLE B

| | Calcifying | | | |
|---|---|---|---|---|
| | Isochrysidales | Dinoflagellates | Diatom | Coccolithophores |
| Image data | 1217 | 344 | 907 | 681 |
| Transient data | 1303 | 326 | 825 | 695 |

TABLE C

| Layer (type) | Output Size | Notes |
|---|---|---|
| Input | (190, 1) | — |
| (Input Layer) | | |
| Layer 1-1 | (190, 32) | Filters = 32, kernel size = 1, |
| (Convolution 1D) | | padding = ‘same’, activation = |
| | | ‘relu’. |
| Layer 1-2 | (190, 32) | Filters = 32, kernel size = 3, |
| (Convolution 1D) | | padding = ‘same’, activation = |
| | | ‘relu’. |
| Layer 1-3 | (190, 32) | Dropout rate = 0.2 |
| (Dropout) | | |
| Layer 2-1 | (190, 32) | Filters = 32, kernel size = 1, |
| (Convolution 1D) | | padding = ‘same’, activation = |
| | | ‘relu’. |
| Layer 2-2 | (190, 32) | Filters = 32, kernel size = 5, |
| (Convolution 1D) | | padding = ‘same’, activation = |
| | | ‘relu’. |
| Layer 2-3 | (190, 32) | Dropout rate = 0.2 |
| (Dropout) | | |
| Layer 3-1 | (190, 1) | Pool_size = 3, strides = 1, |
| (MaxPooling 1D) | | padding = ‘same’ |
| Layer 3-2 | (190, 32) | Filters = 32, kernel size = 1, |
| (Convolution 1D) | | padding = ‘same’, activation = |
| | | ‘relu’. |
| Layer 3-3 | (190, 32) | Dropout rate = 0.2 |
| (Dropout) | | |
| Concatenate | (190, 96) | Concatenates the outputs of |
| (Concatenate) | | Layer 1-3, Layer 2-3 and |
| | | Layer 3-3. |

1. A computer implemented method of classifying a phytoplankton cell comprising:
acquiring transient data indicative of a change in luminescence of the phytoplankton cell after exposure to excitation radiation; and
classifying the phytoplankton cell using the transient data as an input to a trained classifier, wherein the classifier is trained using classified transient data for a plurality of phytoplankton cells.

2. The method of claim 1 further comprising:
acquiring size data indicative of a size of the phytoplankton cell; and
classifying the phytoplankton cell using the transient data and the size data as inputs to the trained classifier, wherein the classifier is trained using classified transient data and size data for a plurality of phytoplankton cells.

3. The method of claim 1 wherein the transient data comprises data indicative of a half-life of a decay in luminescence.

4. The method of claim 1 wherein the classifier comprises a trained K Nearest Neighbours, KNN, classifier.

5. The method of claim 1 wherein; the classifier comprises a neural network; and
classifying the phytoplankton cell comprises processing the transient data using at least one inception block.

6. (canceled)

7. The method of claim 56, further comprising:
concatenating an output of the at least one inception block; and
passing the concatenated output of the at least one inception block to at least one fully connected layer.

8. The method of claim 5, wherein: the transient data is input into an input layer of the neural network; and the method further comprises inputting an auxiliary input into a subsequent layer of the neural network, the auxiliary input comprising size data indicative of a size of the phytoplankton cell.

9. The method of claim 1 further comprising extracting the transient data from a plurality of images of the phytoplankton cell.

10. The method of claim 9 further comprising acquiring the plurality of images sequentially after exposing the cell to excitation radiation.

11. The method of claim 10 further comprising exposing the cell to excitation radiation prior to acquiring the images.

12. The method of claim 1 wherein classifying the phytoplankton cell comprises classifying the cell by at least one of taxonomic order and ecological group.

13. The method of claim 1 wherein the transient data is indicative of the change in luminescence of the phytoplankton cell after exposure to fluorescence excitation and subsequent inhibition of the fluorescence.

14. The method of claim 13 wherein the inhibition of the fluorescence involves contacting the phytoplankton cell with a reactive entity.

15. (canceled)

16. The method of claim 1 wherein the transient data comprises data indicative or one or more wavelengths of light.

17. A computer implemented method of training a classifier to classify a phytoplankton cell comprising:
acquiring classified transient data indicative of a change in luminescence of each of a plurality of phytoplankton cells after exposure to excitation radiation; and
training a classifier using classified transient data for the plurality of phytoplankton cells.

18. The method of claim 17 further comprising:
acquiring labelled size data indicative of a size of the phytoplankton cells;
wherein training the classifier comprises at least one of: (i) training using classified transient data and size data for a plurality of phytoplankton cells and (ii)
extracting the transient data from a plurality of images of the phytoplankton cell.

19.-21. (canceled)

22. A phytoplankton classification apparatus comprising:
a trained classifier trained using labelled transient data for a plurality of phytoplankton cells wherein the transient data is indicative of a change in luminescence of the phytoplankton cell after exposure to excitation, and wherein the classifier is operable, in an operation phase, to receive transient data indicative of a change in luminescence of a phytoplankton cell after exposure to excitation and to classify the phytoplankton cell based on the received transient data.

23. The apparatus of claim 22, further comprising at least one image analysis module to extract the transient data from luminescence images of phytoplankton cells and to provide the transient data to the classifier.

24.-28. (canceled)

29. The apparatus of claim 22 wherein:
the trained classifier comprises a neural network;
the neural network comprises at least one inception block and at least one fully connected layer; and
wherein the classifier is configured to receive an auxiliary input comprising size data indicative of a size of the phytoplankton cell into at least one of the fully connected layers.

30.-32. (canceled)

33. The apparatus of claim 22 further comprising at least one of:
a light source that emits light at a suitable wavelength to induce luminescence of a phytoplankton cell and an electrochemical device to generate a reactive entity for inhibiting luminescence of the phytoplankton cell.

34. (canceled)
